(19) United States
(12) Patent Application Publication
(10) Pub. No.: US 2009/0006208 A1
(43) Pub. Date: Jan. 1, 2009

(54) Display of Video with Tagged Advertising

(76) Inventors: Ranjit Singh Grewal, Brooklyn, NY (US); Daniel Caothien, Brooklyn, NY (US)

Correspondence Address: STIENNON & STIENNON, 612 W. MAIN ST., SUITE 201, P.O. BOX 1667, MADISON, WI, 53701-1667, US

(21) Appl. No.: 12/147,023

(22) Filed: Jun. 26, 2008

Related U.S. Application Data
(60) Provisional application No. 60/946,280, filed on Jun. 26, 2007.

(51) Int. Cl. G06Q 30/00

(52) U.S. Cl. 705/14

(57) ABSTRACT

Tags associated with a video file cause informational images to be displayed at designated times which are correlated to the contents of the video images. The video may be displayed over the internet such that during the display of a video within a portion of the user's display screen, advertiser supplied text and/or images will appear on the display screen in a detail window which are coordinated to the content of the video at a particular time. The content provider's server provides advertising content within the detail window which allows the viewer to pursue multiple levels of content, even including placing an order from the advertiser, all while remaining on the original web page.

### CROSS REFERENCES TO RELATED APPLICATIONS

This application claims the benefit of U.S. provisional app. 60/946,280, filed Jun. 26, 2007, the disclosure of which is incorporated by reference herein.

### BACKGROUND OF THE INVENTION

The present invention relates to methods for displaying information in connection with moving images in general, and more particularly to methods for displaying product and other information about elements of the moving image.

With the greater variety of paid and free media available to consumers, advertisers seek ways to more integrally associate their products with entertainment content. The availability of time-shifting electronic devices compounds the challenge to the traditional advertiser, as the ability to effortlessly remove periodic commercials from television programming becomes more readily available.

One fully integrated approach is the product placement, in which an advertiser's goods are included as props in a dramatic program. Viewers are introduced to the placed product in a seamless fashion, while the advertising content is so much a part of the programming that it is impossible to remove. Yet the consumer who is moved to purchase a placed product must undertake independently to find a retailer for the product of interest.

Computer correlated labels or supplemental information have been proposed for broadcast or cable video programming. A special programming environment can make interactive labels available to the viewer, or offer access to the Internet. The special programming environment offers a unified look and feel to the video display interface, but can be limited in the content available. Access to the Internet through a label offers the full resources of the Internet, but compromises the integrity of the program provider's interface.

What is needed is a system which presents product information correlated to video program material in a fashion which is connected with Internet content on advertisers' servers while offering a controlled interface.

### SUMMARY OF THE INVENTION

The method of the present invention embeds tags within a video file such that informational images are displayed at designated times which are correlated to the contents of the video images. The method may be implemented as an internet application, such that during the display of a video within a portion of the user's display screen, advertising text and/or images will appear on the display screen which are coordinated to the content of the video at a particular time. For example, if an actor in the video is shown reaching for a bottle of beer, a beer advertisement simultaneously appears on the display screen. A viewer may then interact with the beer advertisement, such as by clicking on it with a mouse, to cause further information to appear in a detail window without leaving the viewing page. The viewer may halt the display of the video while investigating the advertisement, or the video may continue uninterrupted. The content displayed in the detail window is provided by the advertiser, not the program provider. The content provider's server, in response to the user's clicking on an advertisement for a placed product, sends a client request to the advertiser's server. The server accepts this client request, and recognizing the application programming interface (API) of the requesting web page, returns the advertising material in an appropriate format to be displayed in a detail window on the application web page. Within the detail window the viewer can pursue multiple levels of content, even including placing an order from the advertiser, all while remaining on the original web page, and even while continuing to watch the program material, if desired.

It is a feature of the present invention to provide a process for associating multiple level advertisements with video programming content without interrupting the continued display of the video programming.

It is another feature of the present invention to provide a process linking advertising displays maintained on the advertiser's server to video programming content on the program provider's server.

Further objects, features and advantages of the invention will be apparent from the following detailed description when taken in conjunction with the accompanying drawings.

### BRIEF DESCRIPTION OF THE DRAWINGS

FIG. 1 is a schematic view of a display screen showing a video programming window with an associated first related advertisement display.

FIG. 2 is a schematic view of a display screen showing the video programming window of FIG. 1 at a later period of time, wherein a second advertisement is displayed which is correlated to the subject matter of the later video display.

FIG. 3 is a schematic view of a display screen showing a video programming window of FIG. 2 at a later period of time, wherein yet an another advertisement is displayed which is correlated to subject matter of the yet later video display.

FIG. 4 is a schematic view of the relationship between the users, the program content provider, and the advertising content providers.

### DESCRIPTION OF THE PREFERRED EMBODIMENTS

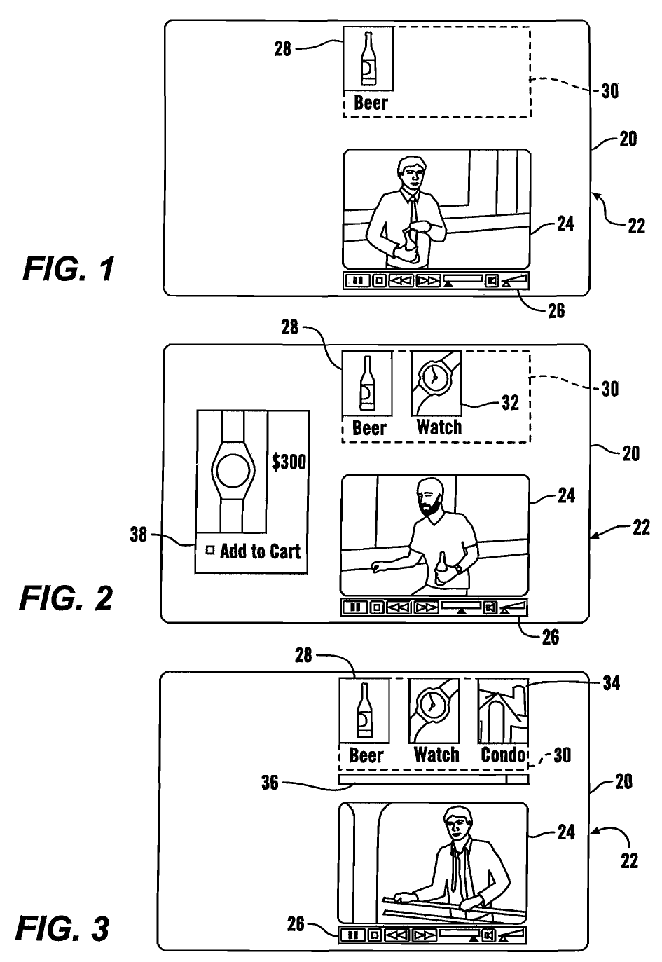

Referring more particularly to FIGS. 1-4 wherein like numbers refer to similar parts, an internet web page 20 is shown which embodies the invention. The page 20 is viewed on a user's video display screen 22 which may be a computer monitor, a television monitor connected to a set-top box connected to the internet, a mobile device such as a cell phone, or some other device capable of displaying moving images. As shown schematically in FIG. 4, the page 20 is provided by the program content provider 40, and may be hosted on the program content provider's own servers. The program content provider provides an interface, not shown, which allows the user to choose which video to display.

The page 20 includes a video display window 24 within which the selected video program material is displayed. The display window 24 has an associated control bar 26 with controls which allow the viewer to pause, play or stop the display of the video, as well as fast forward, reverse, and adjust the volume of the audio portion of the program material.

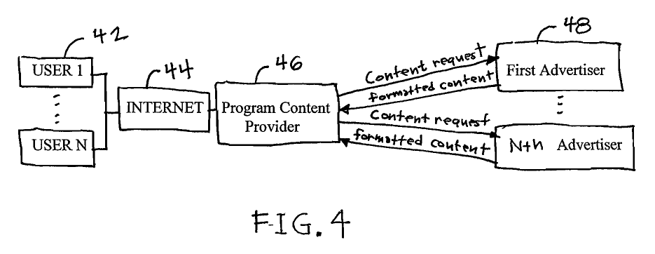

When the viewer activates the play control (not shown), the display of the video program material is initiated within the video display window 24. Tags are associated with the video program material which indicate designated advertisements which are to be displayed at predetermined times of video play. As shown in FIG. 1, a first advertisement 28 is displayed, for example in an advertisement display window 30 above the video display window 24. The first advertisement 28 may comprise a still image with associated text, and preferably is an interactive link through which the viewer can call up more detailed information about the advertised product or service. As shown in FIG. 2, after the video program material has played on to a further predetermined point, a second advertisement 32 is displayed alongside the first in the advertisement display window 30. As shown in FIG. 3, a third advertisement 34 is displayed at a predetermined time in the display of the video program material. When the display area of the advertisement display window 30 can no longer contain all the advertisements, a scroll bar 36 appears, and portions of the earlier advertisements are no longer visible in the advertisement display window 30.

The video program material is prepared by the producer such that tags associate advertisements that are related in some way to the video imagery at a particular point in the duration of the video. For example, as shown in FIG. 1, when a character in the video is pouring a drink, the tag is arranged to cause the appearance of an advertisement for the very beverage which is shown being poured. Later in the video program material, as shown in FIG. 2, when the character checks his watch, a tag is arranged to cause the appearance of an advertisement for a similar timepiece. Or, as the character is shown stepping out onto the balcony of his condominium, a tag may cause an advertisement for a condo development to appear. In a similar manner the video program material progresses to its end, showing advertisements related to the subject matter of the video. The viewer may ignore the displayed advertisements, as they do not interfere with the continued progression of the video program material; or the viewer may use a pointing device such as a mouse to click on the advertisement to display additional information in a detail window 38, as shown in FIG. 2, which will allow the viewer to shop for and purchase the displayed item or a related item, even while the video continues to play. Of course, the viewer may pause the play of the video while shopping or otherwise investigating the advertising in the detail window 38.

The tags and the video with correlated advertisements may be implemented in any desired programming environment. For example, a portion of the web page may be prepared as an Adobe® Flash® animation. In such an implementation, the tags comprise placements of images on the animation timeline to correlate to specific points in the play of the video program material, basically identifying keyframes for the display of advertisments. Alternatively, the application may be implemented utilizing Asynchronous JavaScript and XML (AJAX), which may lead to faster loading and good cross-platform performance. Thus the application may be considered a web 2.0 application.

From the server side, information about viewer activities may be collected for the benefit of advertisers. If desired, viewers can be required to register and submit certain demographic information, such as age and location before being permitted to view page contents. The server can then record which advertisements are clicked by which viewers, to assist the advertiser in determining the effectiveness of the advertisements and the program material. In addition, the demographic data may be employed to restrict or control the advertisements which are displayed. For example, if the viewer's age is below the statutory limit for a particular state, advertisements for alcoholic beverages may be suppressed. Similarly, if the viewer is in a region with prevailing restricted dietary practices, for example India or Saudi Arabia, the display of advertisements for prohibited foods may be suppressed. The server side information may be stored in a Structured Query Language (SQL) database, and reports may be prepared for the benefit of the advertiser.

In addition to displaying advertisements, tags may present additional information about the subject matter of the video being viewed. For example, biographical data or fan club information about a particular actor, or collective advertisements or catalogs related to particular characters, such as showing the closet of a character with displays of all the items of clothing worn by the character with links to additional details about the items as well as places to purchase.

The video program material and the tags indicating the advertisements to be displayed at predetermined times will generally be produced by the same producer. Thus the producer can solicit advertisers for product placements within the program material. Generally the program will be produced in advance of the sales season for the advertised material, such that seasonal clothing for example, can be advertised while still available in retail locations.

The operation of the detail window is shown schematically in FIG. 4. While viewing a selected video in the video display window 22 of the web page 20, an advertisement 32 for a watch, for example, appears in the advertisement display window 30 when the video program in the display window shows an actor wearing a watch. From the user's computer 42, the user selects the watch advertisement, for example by operating a mouse pointing device attached to the computer. This selection action is carried over the Internet 44 to the server 46 or servers maintained by the program content provider, where it is interpreted as a request to display a detail window 38 with advertiser's content relating to the watch. The program content provider's server 46 sends a content request to a server 48 designated by the advertiser for maintaining the appropriate advertising content.

The content request carries with it an indication to the advertiser's server that the content is desired in a format which is compatible with the specific application programming interface (API) of the program content provider's web site. The advertiser's server responds to the request by reformatting the requested content in a format suited to the particular API of the requesting server. As the user browses the formatted content in the detail window 38, the user may continue to select links, manipulate objects, etc., and continue to move to deeper levels of the advertiser's content. With each user activity, the program content provider's server continues to request additional formatted content as needed from the advertiser's server, making available to the user all the requested content maintained by the advertiser, but in a format with a look and feel maintained by the program content provider. In this way the user can continue to view the program material, while simultaneously browsing the information provided and maintained by the advertiser, while having the experience of never departing from the video display web page. This simplifies the viewing and shopping experience, as the user need not be concerned about navigating away from the initial video displaying site. This is beneficial to the program content provider, facilitating complete viewing of its program, as well as to the advertiser, which benefits from an integral association with the program.

For example, the application programming interface may have standard links for each advertised products, which may appear initially in the detail window, along with an image of the product. The standard links may include “Features”, which connects to a description of product features; “Specs”, which connects to a specification of the product; “Buy”, which connects to an interface allowing the user to purchase the product without leaving the program content provider's web page; and “Share & bookmark”, which lets users share the product page via email or social network and bookmark services such as myspace®, del.icio.us®, Digg®, and Google® Bookmarks.

The operator of the program content server will have separately provided the necessary templates to allow the advertisers to format their advertising content to satisfy the API of the program content web page, allowing the advertisers to easily upload the appropriate images and text for their advertisements within the detail window 38.

It is understood that the invention is not limited to the particular construction and arrangement of parts herein illustrated and described, but embraces all such modified forms thereof as come within the scope of the following claims.

We claim:

1. A method for displaying video program material comprising the steps of:
presenting the video program material having subject matter in a video display window of a web page, the web page having an application programming interface associated therewith;
associating tags with the video program material which correlate advertisements to the subject matter of the program material to indicate the display of said advertisements at predetermined times in the video program display; and
displaying a correlated advertisement on the web page with the video program material at the predetermined time for said advertisement, such that the advertisement appears on the web page when the correlated subject matter of the video displays;
in response to an action of a user sending a request for advertising content to an advertising content server; and
receiving the advertising content and displaying the advertising content formatted for the application programming interface on a detail window on the same web page as the video display window.

2. A method of displaying advertisements in correlation with video program material comprising the steps of:
producing a video program material including moving images of placed products which appear within the program material, and determining the times at which said images appear;
producing advertisements for each of said placed products;
correlating the advertisements with the predetermined times at which the images of placed products appear in the video program material, such that an advertisement for a placed product is associated with the predetermined time of appearance of the moving image of the placed product in the video program material;
posting the video program material on a web page accessible through the internet and having an application programming interface, to be activated by an internet user's action;
displaying the correlated advertisements at the predetermined times;
in response to an action of a user sending a request for advertising content to an advertising content server; and
receiving the advertising content and displaying the advertising content formatted for the application programming interface on a detail window on the same web page as the video display window.

3. A method for displaying video program material comprising the steps of:
presenting the video program material having subject matter in a video display window of a web page, the web page having an application programming interface associated therewith;
associating tags with the video program material which correlate advertisements to the subject matter of the program material to indicate the display of said advertisements at predetermined times in the video program display;
displaying a correlated advertisement on the web page with the video program material at the predetermined time for said advertisement, such that the advertisement appears on the web page when the correlated subject matter of the video displays;
in response to an action of a user sending a request for advertising content to an advertising content server, the request containing a signal indicating the application programming interface of the web page;
receiving the request for advertising content and, in response to the signal, formatting advertising content into a format adapted to the application programming interface of the web page, and supplying the formatted requested advertising content; and
receiving the formatted advertising content and displaying the advertising content on a detail window on the same web page as the video display window.
